(19) United States
(12) Patent Application Publication
(10) Pub. No.: US 2022/0066558 A1
(43) Pub. Date: Mar. 3, 2022

(54) ELECTRONIC APPARATUS AND METHOD FOR MANUFACTURING ELECTRONIC APPARATUS

(71) Applicant: MITSUBISHI ELECTRIC CORPORATION, Tokyo (JP)

(72) Inventors: Masahiro KANAMARU, Tokyo (JP); Fuqiang HAN, Tokyo (JP)

(73) Assignee: MITSUBISHI ELECTRIC CORPORATION, Tokyo (JP)

(21) Appl. No.: 17/420,221

(22) PCT Filed: Feb. 8, 2019
(86) PCT No.: PCT/JP2019/004642

§ 371 Date: Jul. 1, 2021

(51) Int. Cl. G06F 3/01; H02K 41/035

(52) U.S. Cl. CPC G06F 3/016; H02K 41/0356

(57) ABSTRACT

An electronic apparatus includes: a touch panel including an operation surface on which touch operation is to be performed; and a voice coil actuator for applying vibrating force to the operation surface in response to the touch operation, in which the voice coil actuator includes: a magnetic circuit unit including an outer peripheral surface of a yoke to be abutted by a guide pin inserted from the rear side with respect to the touch panel so that the guide pin is along the outer peripheral surface, and a magnetic gap formed in an annular shape on the radially inner side with respect to the outer peripheral surface; and a coil unit provided on the rear surface of the touch panel so that a coil having a cylindrical shape is provided in the magnetic gap, and having an outer peripheral shape matching the end shape of the guide pin.

### TECHNICAL FIELD

The present invention relates to an electronic apparatus in which a touch panel is supported to be capable of being vibrated, and a method for manufacturing the electronic apparatus.

### BACKGROUND ART

An electronic apparatus has conventionally been provided that has a function of feeding back vibration to a fingertip of a user in response to the user's touch operation. In the electronic apparatus, a touch panel is supported to be capable of being vibrated, and an actuator is included for applying vibrating force to the touch panel. As such an actuator for the electronic apparatus, a voice coil actuator is often adopted.

The voice coil actuator includes a magnetic circuit unit on a fixed side and a coil unit on a movable side, and vibrates the coil unit with respect to the magnetic circuit unit by generating a magnetic field between the magnetic circuit unit and the coil unit. Furthermore, the voice coil actuator is also adopted as an actuator of a speaker. Then, as such a conventional voice coil actuator, for example, one is disclosed in Patent Literature 1.

### CITATION LIST

### Patent Literature

SUMMARY OF INVENTION

### Technical Problem

The conventional voice coil actuator is an outer magnet type voice coil actuator in which a magnet of the magnetic circuit unit is disposed on the outer side from a coil of the coil unit. In general, in the outer magnet type voice coil actuator, by disposing the magnet on the outer side from the coil, it is possible to increase the size of the magnet, thereby increase the cross-sectional area of the magnet, and thereby increase magnetic flux density in the magnetic circuit unit. The magnitude of the vibrating force exerted by the voice coil actuator is proportional to the magnetic flux density level.

Furthermore, in order for the voice coil actuator to efficiently exert the vibrating force, it is necessary to narrow a gap between a yoke and a pole in the magnetic circuit unit to increase the magnetic flux density, and position the coil in the gap with high accuracy. At this time, when the positioning accuracy of the magnetic circuit unit with respect to the coil unit is insufficient, there is a possibility that the yoke and pole of the magnetic circuit unit come into contact with the coil of the coil unit, and thereby the voice coil actuator is damaged.

The present invention has been made to solve the problem described above, and it is an object to provide an electronic apparatus capable of obtaining vibrating force at a required magnetic flux density level by performance of positioning of a coil unit with respect to a magnetic circuit unit and a method for manufacturing the electronic apparatus.

### Solution to Problem

An electronic apparatus according to the present invention is an electronic apparatus including: a panel including an operation surface on which touch operation is to be performed; and an actuator for applying vibrating force to the operation surface in response to the touch operation, in which the actuator includes: a magnetic circuit unit including an outer peripheral surface to be abutted by a guide pin inserted from a rear side with respect to the panel so that the guide pin is along the outer peripheral surface, the magnetic circuit unit including a magnetic gap formed in an annular shape on a radially inner side with respect to the outer peripheral surface; and a coil unit provided on a rear surface of the panel so that a coil having a cylindrical shape is provided in the magnetic gap, the coil unit having an outer peripheral shape matching an end shape of the guide pin.

An electronic apparatus according to the present invention is an electronic apparatus including: a panel including an operation surface on which touch operation is to be performed; and an actuator for applying vibrating force to the operation surface in response to the touch operation, in which the actuator includes: a magnetic circuit unit including a circuit-side positioning center hole into which a guide pin inserted from a rear side with respect to the panel is to be fitted, the magnetic circuit unit including a magnetic gap formed in an annular shape on a radially outer side with respect to the circuit-side positioning center hole; and a coil unit provided on a rear surface of the panel so that a coil having a cylindrical shape is provided in the magnetic gap, the coil unit including a coil-side positioning center hole into which the guide pin penetrating the circuit-side positioning center hole is to be fitted.

A method for manufacturing an electronic apparatus according to the present invention is a method for manufacturing an electronic apparatus including: a panel including an operation surface on which touch operation is to be performed; and an actuator for applying vibrating force to the operation surface in response to the touch operation, the actuator including: a magnetic circuit unit including a magnetic gap having an annular shape; and a coil unit including a coil which has a cylindrical shape and is provided in the magnetic gap, the method including performing positioning of the coil unit with respect to the magnetic circuit unit by using a guide pin inserted from a rear side with respect to the panel.

### Advantageous Effects Of Invention

According to the present invention, it is possible to obtain the vibrating force at a required magnetic flux density level by performing positioning of the coil unit with respect to the magnetic circuit unit.

### BRIEF DESCRIPTION OF DRAWINGS

FIG. 1 is a front view of an electronic apparatus according to a first embodiment.

FIG. 2 is a cross-sectional arrow view taken along the line II-II of FIG. 1.

FIG. 3 is a cross-sectional arrow view taken along the line of FIG. 1.

FIG. 4 is a set of diagrams illustrating a configuration of a conventional electronic apparatus. FIG. 4A is a diagram illustrating a mounting structure of a conventional voice coil actuator. FIG. 4B is a diagram of a conventional magnetic circuit unit as viewed from the rear end surface side of a yoke.

FIG. 5 is a set of diagrams illustrating a comparison of magnetic flux density between the electronic apparatus according to the first embodiment and the conventional electronic apparatus. FIG. 5A is a diagram illustrating how magnetic flux is generated in the conventional magnetic circuit unit. FIG. 5B is a diagram illustrating how magnetic flux is generated in a magnetic circuit unit according to the first embodiment.

FIG. 6 is a diagram illustrating a mounting structure of a voice coil actuator in an electronic apparatus according to a second embodiment.

FIG. 7 is a set of diagrams illustrating a configuration of an electronic apparatus according to a third embodiment. FIG. 7A is a diagram illustrating a mounting structure of a voice coil actuator. FIG. 7B is a diagram of a magnetic circuit unit as viewed from the rear end surface side of a yoke.

FIG. 8 is a diagram illustrating a mounting structure of a voice coil actuator in an electronic apparatus according to a fourth embodiment.

### DESCRIPTION OF EMBODIMENTS

Hereinafter, to explain the present invention in more detail, embodiments for carrying out the present invention will be described with reference to the accompanying drawings.

### First Embodiment

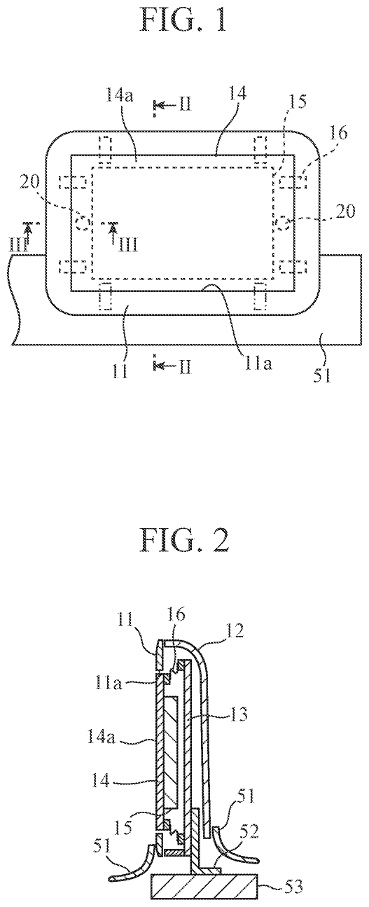

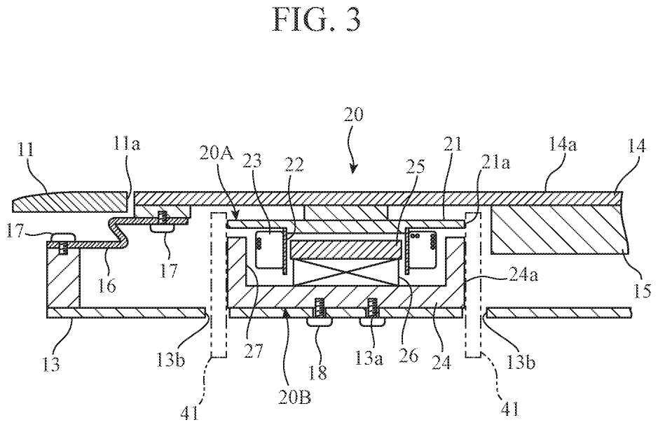

First, a configuration of an electronic apparatus according to a first embodiment will be described with reference to FIGS. 1 to 3. FIG. 1 is a front view of the electronic apparatus according to the first embodiment. FIG. 2 is a cross-sectional arrow view taken along the line II-II of FIG. 1. FIG. 3 is a cross-sectional arrow view taken along the line of FIG. 1.

The electronic apparatus according to the first embodiment is an in-vehicle device installed in a vehicle, and has a function of feeding back vibration to a fingertip of a user in response to the user's touch operation. The electronic apparatus includes a front design panel 11, a rear design panel 12, a main body chassis 13, a touch panel 14, a liquid crystal panel 15, springs 16, and voice coil actuators 20. On the other hand, a vehicle interior of the vehicle is provided with a vehicle panel 51, a mounting plate 52, and a vehicle fixing part 53.

The front design panel 11 and the rear design panel 12 constitute an outer shell of the electronic apparatus and are joined to each other. The front design panel 11 is disposed at the front of the electronic apparatus and has a rectangular frame shape. The front design panel 11 includes an opening 11a having a rectangular shape. The rear design panel 12 is disposed at the rear of the electronic apparatus and has a rectangular plate shape. Then, a lower edge portion of the front design panel 11 and a lower edge portion of the rear design panel 12 are covered by the vehicle panel 51 from the outer side and fixed to the vehicle panel 51.

The main body chassis 13, the touch panel 14, the liquid crystal panel 15, the springs 16, and the voice coil actuators 20 are provided in an internal space formed by mounting the front design panel 11 and the rear design panel 12 on each other. Among these, the main body chassis 13 is fixed to the vehicle fixing part 53 via the mounting plate 52.

Both the touch panel 14 and the liquid crystal panel 15 have a rectangular shape, and the touch panel 14 is a panel larger than the liquid crystal panel 15. Then, the rear surface of the touch panel 14 and the front surface of the liquid crystal panel 15 are bonded to each other. At this time, the liquid crystal panel 15 is located in a central portion of the touch panel 14, and the liquid crystal panel 15 is not bonded to an outer peripheral edge portion on the rear surface of the touch panel 14.

The touch panel 14 is housed in the opening 11a of the front design panel 11 in a state of being bonded to the liquid crystal panel 15. The front surface of the touch panel 14 is exposed from the opening 11a of the front design panel 11 and faces forward, and forms an operation surface 14a. The operation surface 14a accepts the touch operation from the user.

The spring 16 is connected in a bent state between the front surface of the main body chassis 13 and the outer peripheral edge portion on the rear surface of the touch panel 14. Both ends of the spring 16 are fixed with use of screws 17. As a result, the touch panel 14 is supported with utilization of elastic force of the spring 16 to be capable of being vibrated with respect to the main body chassis 13. That is, the touch panel 14 is in a floating state with respect to the main body chassis 13.

A plurality of the voice coil actuators 20 is provided between the front surface of the main body chassis 13 and the outer peripheral edge portion on the rear surface of the touch panel 14. The voice coil actuators 20 illustrated in FIGS. 1 and 3 are provided on only the left and right peripheral edge portions on the rear surface of the touch panel 14; however, in addition to this, the voice coil actuators 20 may be provided on the upper and lower peripheral edge portions on the rear surface. Furthermore, the voice coil actuators 20 may be provided on only the upper and lower peripheral edge portions on the rear surface of the touch panel 14. That is, the number and positions of the voice coil actuators 20 can be adjusted as appropriate.

Moreover, the voice coil actuator 20 has a circular outer shape, and includes a coil unit 20A and a magnetic circuit unit 20B. The coil unit 20A and the magnetic circuit unit 20B are arranged coaxially. Then, the coil unit 20A is bonded to the outer peripheral edge portion on the rear surface of the touch panel 14. On the other hand, the magnetic circuit unit 20B is fixed to the front surface of the main body chassis 13.

The coil unit 20A includes a pusher 21, a coil bobbin 22, and a coil 23. The pusher 21 has a circular shape, and the front surface of the pusher 21 is bonded to the rear surface of the touch panel 14. The coil bobbin 22 has a cylindrical shape and is provided on the rear surface of the pusher 21. The coil 23 serves as a vibration source for the voice coil actuator 20, and is wound around the outer peripheral surface of the coil bobbin 22.

The magnetic circuit unit 20B includes a yoke 24, a pole 25, a magnet 26, and a magnetic gap 27. The yoke 24 and the pole 25 are each made of a magnetic material.

The yoke 24 includes a bottom plate portion having a circular shape and a cylindrical portion. The bottom plate portion of the yoke 24 is fixed to the front surface of the main body chassis 13 with use of screws 18. The screws 18 are fastened to the bottom plate portion of the yoke 24 from the rear of the main body chassis 13 penetrating through holes 13a formed in the main body chassis 13.

The pole 25 and the magnet 26 each have a circular shape, and are arranged to be coaxially overlapped with each other in the cylindrical portion of the yoke 24. The magnet 26 is provided on the bottom surface of the yoke 24, and the pole 25 is provided on the front surface of the magnet 26. Note that, the outer diameter of the pole 25 is greater than or equal to the outer diameter of the magnet 26.

Then, the magnetic gap 27 having an annular shape is formed between the inner peripheral surface of the cylindrical portion of the yoke 24 and the outer peripheral surface of the pole 25. An outer peripheral surface 24a of the yoke 24 is the outer peripheral surface of the magnetic circuit unit 20B, and the magnetic gap 27 is formed in an annular shape on the radially inner side with respect to the outer peripheral surface 24a. On the other hand, the coil 23 wound around the outer peripheral surface of the coil bobbin 22 is disposed in the magnetic gap 27. As a result, the magnet 26 is disposed inside the coil 23. As described above, the voice coil actuator 20 has a configuration in which the magnet 26 is disposed inside the coil 23, thereby being an inner magnet type voice coil actuator.

Thus, in the voice coil actuator 20, due to interaction between an oscillating current supplied to the coil 23 and magnetic flux flowing from the pole 25 toward the yoke 24 in the magnetic gap 27, the coil 23 vibrates in the axial direction of the coil unit 20A integrally with the coil bobbin 22. Then, the vibration generated by the voice coil actuator 20 is transmitted to the touch panel 14.

That is, the front design panel 11, the rear design panel 12, the main body chassis 13, and the magnetic circuit unit 20B are fixed portions fixed to the vehicle among the members constituting the electronic apparatus. On the other hand, the touch panel 14, the liquid crystal panel 15, and the coil unit 20A are movable portions supported by the spring 16 to be capable of being vibrated with respect to the fixed portions.

Furthermore, the outer diameter of the pusher 21 in the coil unit 20A and the outer diameter of the yoke 24 in the magnetic circuit unit 20B have the same dimensions. As a result, in the electronic apparatus according to the first embodiment, an outer peripheral surface 21a of the pusher 21 that is the outer peripheral surface of the coil unit 20A, and the outer peripheral surface of the yoke 24 that is the outer peripheral surface of the magnetic circuit unit 20B are coaxially arranged, and thereby positioning of the coil unit 20A with respect to the magnetic circuit unit 20B is performed in the voice coil actuator 20. As a result, in the electronic apparatus according to the first embodiment, the magnetic gap 27 having an annular shape can be held with a uniform width over the entire circumference.

In the electronic apparatus according to the first embodiment, three or more guide pins 41 are used to highly accurately perform positioning of the coil unit 20A with respect to the magnetic circuit unit 20B in the voice coil actuator 20 at the time of manufacturing the electronic apparatus. The guide pins 41 are shaft members each having a circular cross section. On the other hand, the main body chassis 13 includes a plurality of pin insertion holes 13b. The pin insertion holes 13b are arranged at positions corresponding to the outer diameter of the yoke 24. As a result, the multiple guide pins 41 are arranged on the same circumference by being inserted into the respective pin insertion holes 13b.

The guide pins 41 are used by being inserted into the pin insertion holes 13b of the main body chassis 13 from the rear side with respect to the touch panel 14. At this time, the guide pins 41 inserted from the pin insertion holes 13b abut the outer peripheral surface 24a of the yoke 24 to be along the axial direction of the magnetic circuit unit 20B, and the end shapes of the guide pins 41 match the outer peripheral shape of the coil unit 20A. Specifically, the outer peripheral surfaces of the end portions of the guide pins 41 abut the outer peripheral surface of the pusher 21 that is the outer peripheral shape of the coil unit 20A in such a manner as to be along the outer peripheral surface of the pusher 21. As a result, the outer peripheral surface 21a of the pusher 21 is aligned conforming to the outer peripheral surfaces of the guide pins 41, and thereby is positioned in a state of being disposed coaxially with the outer peripheral surface 24a of the yoke 24.

Next, a method for manufacturing the electronic apparatus according to the first embodiment will be described with reference to FIG. 3.

First, the rear surface of the touch panel 14 and the front surface of the liquid crystal panel 15 are bonded to each other. Furthermore, one end of the spring 16 is fixed to the outer peripheral edge portion on the rear surface of the touch panel 14 with use of the screw 17.

Next, the outer peripheral edge portion on the rear surface of the touch panel 14 and the front surface of the pusher 21 in the coil unit 20A are bonded to each other. As a result, assembly of the movable portions is completed.

Then, the multiple guide pins 41 are inserted into the pin insertion holes 13b of the main body chassis 13.

Subsequently, the magnetic circuit unit 20B is fitted into the inner side with respect to the multiple guide pins 41 arranged on the same circumference, and is seated on the front surface of the main body chassis 13. At this time, the guide pins 41 abut the outer peripheral surface 24a of the yoke 24 to be along the axial direction of the magnetic circuit unit 20B. As a result, the magnetic circuit unit 20B is positioned at a predetermined mounting position.

Next, the magnetic circuit unit 20B is fixed to the front surface of the main body chassis 13 with use of the screws 18.

Then, the pusher 21 of the coil unit 20A is fitted into the inner side with respect to the guide pins 41 arranged on the same circumference. As a result, the coil unit 20A is positioned with respect to the fixed magnetic circuit unit 20B in the radial direction of the voice coil actuator 20. As a result, the magnetic gap 27 having an annular shape is held with a uniform width over the entire circumference.

Subsequently, the other end of the spring 16 is fixed to the front surface of the main body chassis 13 with use of the screw 17.

Next, the guide pins 41 are pulled out from the pin insertion holes 13b of the main body chassis 13.

Then, after the touch panel 14 is fitted into the opening 11a of the front design panel 11, the front design panel 11 and the rear design panel 12 that covers the main body chassis 13 from the rear are assembled.

As described above, in the electronic apparatus according to the first embodiment, positioning of the coil unit 20A with respect to the magnetic circuit unit 20B is possible by using the guide pins 41 at the time of manufacturing the electronic apparatus. As a result, in the electronic apparatus according to the first embodiment, the magnetic gap 27 can be made to have a uniform width over the entire circumference, and can be narrowed. Moreover, in the electronic apparatus according to the first embodiment, the pin insertion holes 13b for inserting the guide pins 41 are included in the main body chassis 13, but the pin insertion holes are not included in the yoke 24 that is a path for magnetic flux generated by the magnet 26. Thus, in the electronic apparatus according to the first embodiment, a decrease in the magnetic flux density in the magnetic gap 27 can be prevented.

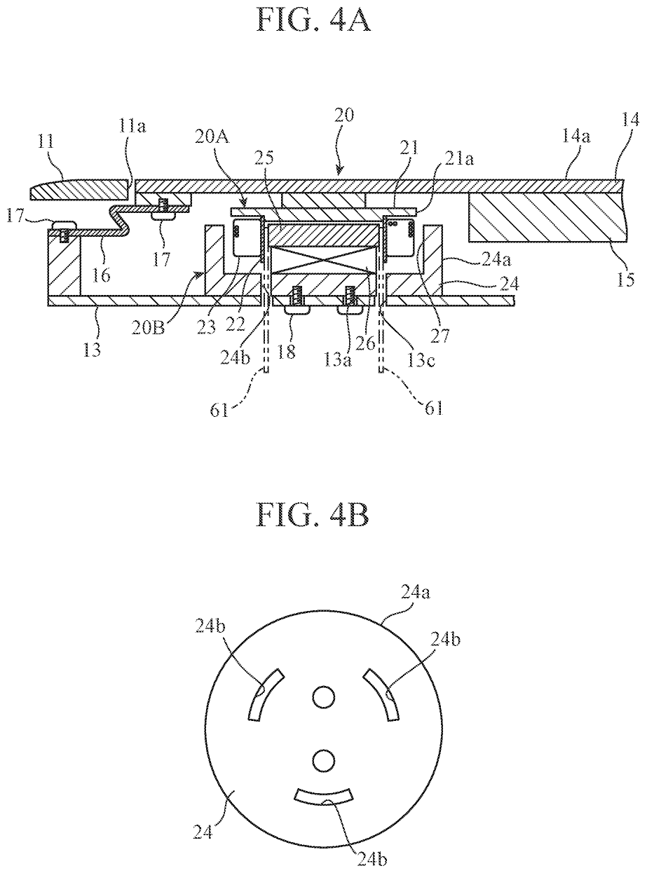

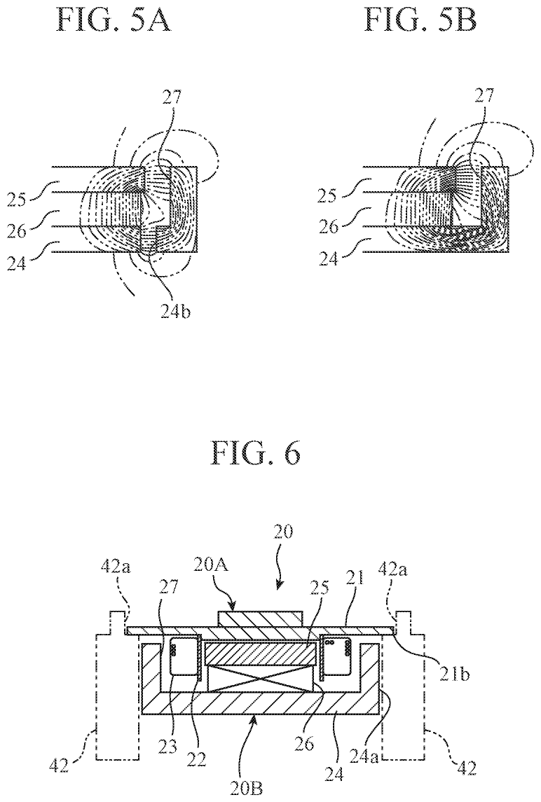

Next, a comparison of the magnetic flux density between the electronic apparatus according to the first embodiment and a conventional electronic apparatus will be described with reference to FIGS. 4 and 5. FIG. 4A is a diagram illustrating a mounting structure of a conventional voice coil actuator. FIG. 4B is a diagram of a conventional magnetic circuit unit as viewed from the rear end surface side of the yoke. FIG. 5A is a diagram illustrating how magnetic flux is generated in the conventional magnetic circuit unit. FIG. 5B is a diagram illustrating how magnetic flux is generated in the magnetic circuit unit according to the first embodiment.

In the conventional electronic apparatus illustrated in FIG. 4, a positioning structure disclosed in Patent Literature 1 described above is applied, and a feeler gauge 61 is used for positioning of the coil unit 20A with respect to the magnetic circuit unit 20B. The feeler gauge 61 is for managing a gap between the inner peripheral surface of the coil bobbin 22 and the outer peripheral surface of the pole 25. Since the conventional electronic apparatus includes the touch panel 14 at the front, the feeler gauge 61 is inserted into gauge insertion holes 13c of the main body chassis 13 from the rear side with respect to the touch panel 14 similarly to the guide pins 41 according to the first embodiment. As a result, the conventional electronic apparatus needs to include gauge insertion holes 24b in the yoke 24 for inserting the feeler gauge 61.

Thus, as illustrated in FIG. 5A, in the conventional electronic apparatus, the gauge insertion hole 24b is included in the yoke 24, whereby the magnetic resistance is increased due to the gauge insertion hole 24b, and accordingly, the magnetic flux density in the magnetic gap 27 decreases. On the other hand, as illustrated in FIG. 5B, since the electronic apparatus according to the first embodiment does not include the gauge insertion hole 24b in the yoke 24, the magnetic flux density is maintained in the yoke 24, and accordingly, the magnetic flux density in the magnetic gap 27 is improved.

Furthermore, the electronic apparatus according to the first embodiment includes the inner magnet type voice coil actuator 20, whereby the magnet 26 is disposed inside the coil 23 to reduce the size of the magnet 26 and to reduce the size of the entire electronic apparatus. In the inner magnet type voice coil actuator 20, although the magnet 26 can be made smaller in comparison with the outer magnet type voice coil actuator, the cross-sectional area of the magnet 26 is smaller by that amount, which may lead to a decrease in magnetic flux density.

However, in the electronic apparatus according to the first embodiment, even if the inner magnet type voice coil actuator 20 is adopted, positioning of the coil unit 20A with respect to the magnetic circuit unit 20B can be performed with high accuracy with use of the guide pins 41, so that the magnetic gap 27 can be narrowed to improve the magnetic flux density. When vibrating force is F, magnetic flux density is B, coil wire length is L, and current flowing through the coil 23 is i, a relational expression F=B*L*i is obtained. As is clear from the relational expression, in the electronic apparatus according to the first embodiment, larger vibrating force can be obtained by improving the magnetic flux density.

From the above, the electronic apparatus according to the first embodiment includes the touch panel 14 including the operation surface 14a on which touch operation is to be performed, and the voice coil actuator 20 for applying vibrating force to the operation surface 14a in response to the touch operation. Moreover, the voice coil actuator 20 includes: the magnetic circuit unit 20B including the outer peripheral surface 24a to be abutted by the guide pins 41 inserted from the rear side with respect to the touch panel 14 so that the guide pins are along the outer peripheral surface 24a, and the magnetic gap 27 formed in an annular shape on the radially inner side with respect to the outer peripheral surface 24a; and the coil unit 20A provided on the rear surface of the touch panel 14 so that the coil 23 having a cylindrical shape is provided in the magnetic gap 27, and having an outer peripheral shape matching the end shapes of the guide pins 41. As a result, in the electronic apparatus according to the first embodiment, the outer peripheral surfaces of the end portions of the guide pins 41 abut the outer peripheral surface 21a of the pusher 21 that is the outer peripheral shape of the coil unit 20A in such a manner as to be along the outer peripheral surface 21a, so that positioning of the coil unit 20A with respect to the magnetic circuit unit 20B is performed, whereby the vibrating force can be obtained at a required magnetic flux density level.

Furthermore, in the method for manufacturing the electronic apparatus according to the first embodiment, positioning of the coil unit 20A with respect to the magnetic circuit unit 20B in the voice coil actuator 20 is performed by using the guide pins 41 inserted from the rear side with respect to the touch panel 14. At this time, the guide pins 41 abut the outer peripheral surface 24a of the magnetic circuit unit 20B to be along the outer peripheral surface 24a, and the end shapes of the guide pins 41 and the outer peripheral shape of the coil unit 20A are matched. As a result, in the electronic apparatus according to the first embodiment, the vibrating force can be obtained at a required magnetic flux density level.

### Second Embodiment

An electronic apparatus according to a second embodiment will be described with reference to FIG. 6. FIG. 6 is a diagram illustrating a mounting structure of a voice coil actuator in the electronic apparatus according to the second embodiment.

In the electronic apparatus according to the second embodiment illustrated in FIG. 6, the outer diameter of the pusher 21 is larger than the outer diameter of the yoke 24, so that guide pins 42 are used, instead of the guide pins 41 according to the first embodiment, in positioning of the coil unit 20A with respect to the magnetic circuit unit 20B.

Each of the guide pins 42 is a shaft member having a circular cross section, and is a stepped guide pin. The guide pin 42 has a step 42a that is an end shape of the guide pin 42. The step 42a fits with an outer peripheral corner portion 21b of the pusher 21 that is the outer peripheral shape of the coil unit 20A. As a result, the outer peripheral corner portion 21b of the pusher 21 is aligned conforming to the step 42a of the guide pin 42, and thereby is positioned in a state of being disposed coaxially with the outer peripheral surface 24a of the yoke 24.

From the above, the voice coil actuator 20 of the electronic apparatus according to the second embodiment includes: the magnetic circuit unit 20B including the outer peripheral surface 24a to be abutted by the guide pins 42 inserted from the rear side with respect to the touch panel 14 so that the guide pins 42 are along the outer peripheral surface 24a, and the magnetic gap 27 formed in an annular shape on the radially inner side with respect to the outer peripheral surface 24a; and the coil unit 20A provided on the rear surface of the touch panel 14 so that the coil 23 having a cylindrical shape is provided in the magnetic gap 27, and having an outer peripheral shape matching the end shapes of the guide pins 42. As a result, in the electronic apparatus according to the second embodiment, even when the outer diameter of the pusher 21 is larger than the outer diameter of the yoke 24, the step 42a formed at the end portion of the guide pin 42 fits with the outer peripheral corner portion 21b of the pusher 21 that is the outer peripheral shape of the coil unit 20A, so that positioning of the coil unit 20A with respect to the magnetic circuit unit 20B is performed, whereby the vibrating force can be obtained at a required magnetic flux density level.

Furthermore, in a method for manufacturing the electronic apparatus according to the second embodiment, positioning of the coil unit 20A with respect to the magnetic circuit unit 20B in the voice coil actuator 20 is performed by using the guide pins 42 inserted from the rear side with respect to the touch panel 14. At this time, the guide pins 42 abut the outer peripheral surface 24a of the magnetic circuit unit 20B to be along the outer peripheral surface 24a, and the end shapes of the guide pins 42 and the outer peripheral shape of the coil unit 20A are matched. As a result, in the electronic apparatus according to the second embodiment, the vibrating force can be obtained at a required magnetic flux density level.

### Third Embodiment

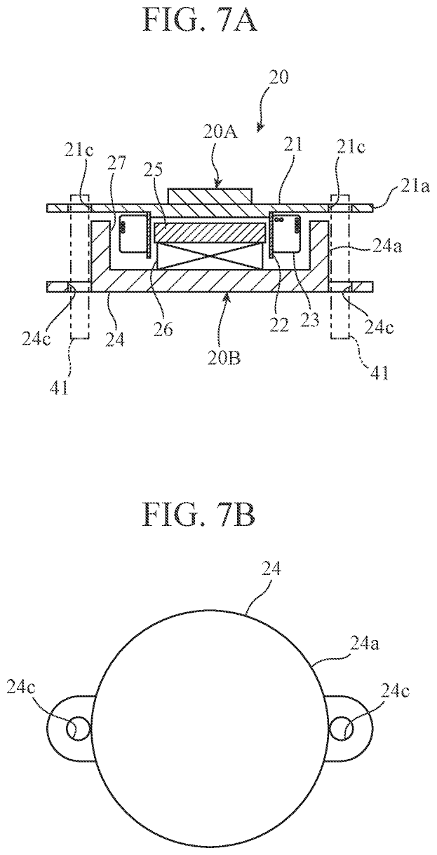

An electronic apparatus according to a third embodiment will be described with reference to FIG. 7. FIG. 7A is a diagram illustrating a mounting structure of the voice coil actuator. FIG. 7B is a diagram of the magnetic circuit unit as viewed from the rear end surface side of the yoke.

In the electronic apparatus according to the third embodiment illustrated in FIGS. 7A and 7B, the outer diameter of the pusher 21 is larger than the outer diameter of the yoke 24 in positioning of the coil unit 20A with respect to the magnetic circuit unit 20B, so that positioning holes 21c and 24c are added to the configuration of the electronic apparatus according to the first embodiment.

The pusher 21 includes the positioning holes 21c. The positioning holes 21c constitute coil-side positioning holes, and are arranged on the radially inner side with respect to the outer peripheral surface 21a of the pusher 21. Furthermore, the yoke 24 includes the positioning holes 24c. The positioning holes 24c constitute circuit-side positioning holes, and are arranged on the radially outer side with respect to the outer peripheral surface 24a of the yoke 24. Then, the guide pins 41 can be fitted into the positioning holes 21c and 24c. As a result, the outer peripheral surface 21a of the pusher 21 is aligned by fitting the guide pins 41 penetrating the positioning holes 24c of the yoke 24 into the positioning holes 21c, and thereby is positioned in a state of being disposed coaxially with the outer peripheral surface 24a of the yoke 24.

From the above, the voice coil actuator 20 of the electronic apparatus according to the third embodiment includes the positioning holes 21c provided on the radially inner side with respect to the outer peripheral surface 21a of the coil unit 20A, and the positioning holes 24c provided on the radially outer side with respect to the outer peripheral surface 24a of the magnetic circuit unit 20B. The guide pins 41 are fitted into the positioning holes 21c and 24c. As a result, in the electronic apparatus according to the third embodiment, even when the outer diameter of the pusher 21 is larger than the outer diameter of the yoke 24, the guide pins 41 are fitted into the positioning holes 21c and 24c, so that positioning of the coil unit 20A with respect to the magnetic circuit unit 20B is performed, whereby the vibrating force can be obtained at a required magnetic flux density level.

Furthermore, in a method for manufacturing the electronic apparatus according to the third embodiment, positioning of the coil unit 20A with respect to the magnetic circuit unit 20B in the voice coil actuator 20 is performed by using the guide pins 41 inserted from the rear side with respect to the touch panel 14. At this time, the guide pins 41 abut the outer peripheral surface 24a of the magnetic circuit unit 20B to be along the outer peripheral surface 24a, and the end portions of the guide pins 41 and the positioning holes 21c of the coil unit 20A are matched. As a result, in the electronic apparatus according to the third embodiment, the vibrating force can be obtained at a required magnetic flux density level.

### Fourth Embodiment

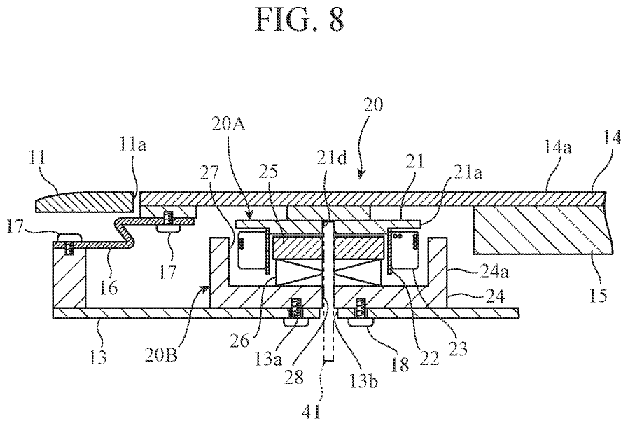

An electronic apparatus according to a fourth embodiment will be described with reference to FIG. 8. FIG. 8 is a diagram illustrating a mounting structure of a voice coil actuator in the electronic apparatus according to the fourth embodiment.

In the electronic apparatus according to the fourth embodiment illustrated in FIG. 8, a positioning center hole 21d and a positioning center hole 28 are added to the configuration of the electronic apparatus according to the first embodiment.

The magnetic circuit unit 20B includes the positioning center hole 28. The positioning center hole 28 constitutes a circuit-side positioning center hole, and penetrates central portions of the yoke 24, the pole 25, and the magnet 26. At this time, since the central portions of the yoke 24, the pole 25, and the magnet 26 are located at positions where the magnetic flux is not dense, the positioning center hole 28 penetrating the central portions does not disturb the magnetic flux. Thus, even if the positioning center hole 28 is included, the magnetic circuit unit 20B can suppress a decrease in the magnetic flux density in the magnetic gap 27. Furthermore, the coil unit 20A includes the positioning center hole 21d in the pusher 21. The positioning center hole 21d constitutes a coil-side positioning center hole and penetrates a central portion of the pusher 21.

Then, one guide pin 41 is used, and the guide pin 41 can be fitted into the positioning center holes 21d and 28. The guide pin 41 is fitted into the positioning center hole 28, then penetrates the positioning center hole 28, and is fitted into the positioning center hole 21d. As a result, a central portion of the coil unit 20A is aligned by fitting the guide pin 41 penetrating the positioning center hole 28 of the magnetic circuit unit 20B into the positioning center hole 21d, and thereby is positioned in a state of being disposed coaxially with a central portion of the magnetic circuit unit 20B.

From the above, the voice coil actuator 20 in the electronic apparatus according to the fourth embodiment includes: the magnetic circuit unit 20B including the positioning center hole 28 into which the guide pin 41 inserted from the rear side with respect to the touch panel 14 is to be fitted, and the magnetic gap 27 formed in an annular shape on the radially outer side with respect to the positioning center hole 28; and the coil unit 20A provided on the rear surface of the touch panel 14 so that the coil 23 having a cylindrical shape is provided in the magnetic gap 27, and including the positioning center hole 21d into which the guide pin 41 penetrating the positioning center hole 28 is to be fitted. As a result, in the electronic apparatus according to the fourth embodiment, regardless of the magnitude relationship between the outer diameter of the pusher 21 and the outer diameter of the yoke 24, positioning of the coil unit 20A with respect to the magnetic circuit unit 20B is performed, whereby the vibrating force can be obtained at a required magnetic flux density level.

Furthermore, in a method for manufacturing the electronic apparatus according to the fourth embodiment, positioning of the coil unit 20A with respect to the magnetic circuit unit 20B in the voice coil actuator 20 is performed by using the guide pin 41 inserted from the rear side with respect to the touch panel 14. At this time, the guide pin 41 is fitted into the positioning center hole 28 of the magnetic circuit unit 20B, and the end portion of the guide pin 41 penetrating the positioning center hole 28 is fitted into the positioning center hole 21d of the coil unit 20A. As a result, in the electronic apparatus according to the fourth embodiment, the vibrating force can be obtained at a required magnetic flux density level.

The electronic apparatuses according to the first to fourth embodiments described above can be applied to all the configurations, such as a configuration in which the outer diameter of the coil unit 20A and the outer diameter of the magnetic circuit unit 20B have the same dimensions, a configuration in which the outer diameter of the coil unit 20A is larger than the outer diameter of the magnetic circuit unit 20B, and a configuration in which the outer diameter of the coil unit 20A is smaller than the outer diameter of the magnetic circuit unit 20B.

Furthermore, although the guide pins 41 and 42 are shaft members each having a circular cross section, they may each have a cross-sectional shape other than a circle, such as a square and an ellipse. On the other hand, hole shapes of the positioning holes 21c and 24c, and the positioning center holes 21d and 28 may be any hole shapes as long as the guide pins 41 and 42 can be fitted into the positioning holes 21c and 24c, and the positioning center holes 21d and 28.

Note that, in the invention of the present application, within the scope of the invention, free combination of embodiments, a modification of any component of each embodiment, or omission of any component in each embodiment is possible.

### INDUSTRIAL APPLICABILITY

The electronic apparatus and the method for manufacturing the electronic apparatus according to the present invention make it possible to perform positioning of a magnetic circuit unit with respect to a coil unit in an actuator by using a guide pin, and thus are suitable for use in an electronic apparatus in which a touch panel is supported to be capable of being vibrated, a method for manufacturing the electronic apparatus, and the like.

### REFERENCE SIGNS LIST

11: front design panel, 11a: opening, 12: rear design panel, 13: main body chassis, 13a: through hole, 13b: pin insertion hole, 13c: gauge insertion hole, 14: touch panel, 14a: operation surface, 15: liquid crystal panel, 16: spring, 17, 18: screw, 20: voice coil actuator, 20A: coil unit, 20B: magnetic circuit unit, 21: pusher, 21a: outer peripheral surface, 21b: outer peripheral corner portion, 21c: positioning hole, 21d: positioning center hole, 22: coil bobbin, 23: coil, 24: yoke, 24a: outer peripheral surface, 24b: gauge insertion hole, 24c: positioning hole, 25: pole, 26: magnet, 27: magnetic gap, 28: positioning center hole, 41, 42: guide pin, 42a: step, 51: vehicle panel, 52: mounting plate, 53: vehicle fixing part, 61: feeler gauge

1. An electronic apparatus comprising: a panel including an operation surface on which touch operation is to be performed; and an actuator for applying vibrating force to the operation surface in response to the touch operation, wherein
the actuator includes:
a magnetic circuit unit including an outer peripheral surface to be abutted by a guide pin inserted from a rear side with respect to the panel so that the guide pin is along the outer peripheral surface, the magnetic circuit unit including a magnetic gap formed in an annular shape on a radially inner side with respect to the outer peripheral surface; and
a coil unit provided on a rear surface of the panel so that a coil having a cylindrical shape is provided in the magnetic gap, the coil unit having an outer peripheral shape matching an end shape of the guide pin.

2. The electronic apparatus according to claim 1, wherein
an outer peripheral surface of the coil unit is to be abutted by an outer peripheral surface of an end portion of the guide pin so that the outer peripheral surface of the end portion is along the outer peripheral surface of the coil unit.

3. The electronic apparatus according to claim 1, wherein
an outer peripheral corner portion of the coil unit is to fit with a step formed at an end portion of the guide pin.

4. The electronic apparatus according to claim 1, further comprising:
a circuit-side positioning hole provided on a radially outer side with respect to the outer peripheral surface of the magnetic circuit unit; and
a coil-side positioning hole provided on a radially inner side with respect to an outer peripheral surface of the coil unit, wherein
the guide pin is fitted into the circuit-side positioning hole and the coil-side positioning hole.

5. An electronic apparatus comprising: a panel including an operation surface on which touch operation is to be performed; and an actuator for applying vibrating force to the operation surface in response to the touch operation, wherein
the actuator includes:
a magnetic circuit unit including a circuit-side positioning center hole into which a guide pin inserted from a rear side with respect to the panel is to be fitted, the magnetic circuit unit including a magnetic gap formed in an annular shape on a radially outer side with respect to the circuit-side positioning center hole; and
a coil unit provided on a rear surface of the panel so that a coil having a cylindrical shape is provided in the magnetic gap, the coil unit including a coil-side positioning center hole into which the guide pin penetrating the circuit-side positioning center hole is to be fitted.

6. A method for manufacturing an electronic apparatus including: a panel including an operation surface on which touch operation is to be performed; and an actuator for applying vibrating force to the operation surface in response to the touch operation,
the actuator including:
a magnetic circuit unit including a magnetic gap having an annular shape; and
a coil unit including a coil which has a cylindrical shape and is provided in the magnetic gap,
the method comprising
performing positioning of the coil unit with respect to the magnetic circuit unit by using a guide pin inserted from a rear side with respect to the panel.

7. The method for manufacturing an electronic apparatus according to claim 6, wherein
the guide pin is caused to abut an outer peripheral surface of the magnetic circuit unit to be along the outer peripheral surface, and
an end shape of the guide pin and an outer peripheral shape of the coil unit are matched.

8. The method for manufacturing an electronic apparatus according to claim 6, wherein
the guide pin is fitted into a circuit-side positioning center hole of the magnetic circuit unit, and
an end portion of the guide pin penetrating the circuit-side positioning center hole is fitted into a coil-side positioning center hole of the coil unit.
